(19) United States
(12) Patent Application Publication
(10) Pub. No.: US 2012/0323890 A1
(43) Pub. Date: Dec. 20, 2012

(54) System and Method of Event Networking

(75) Inventors: Ronald Wayne Dixon, Riverton, UT (US); Deann G. Dixon, Riverton, UT (US); Leanna Rae Scott, Herriman, UT (US); Ira Tiffen, Herriman, UT (US)

(73) Assignee: Wild Ventures LLC, Riverton, UT (US)

(21) Appl. No.: 13/517,853

(22) Filed: Jun. 14, 2012

Related U.S. Application Data
(60) Provisional application No. 61/496,668, filed on Jun. 14, 2011.

(51) Int. Cl. G06F 17/30

(52) U.S. Cl. 707/722; 707/737; 707/E17.014; 707/E17.046

(57) ABSTRACT

A system and method for organizing things (including persons, creatures, objects, thoughts, affairs, circumstances, actions, events, objectives, tasks, statements, attitudes, emotions, symbols, ideas, and information) using various relationships. Such a system and method may be used for documenting, searching, networking, and connecting, either individually or collaboratively. Such an Event Networking system, which encompasses events, persons, objects, activities, emotions, interests, etc., can be organized in relation to time, location, etc.

### CROSS-REFERENCE TO RELATED APPLICATIONS

This application claims priority under 35 U.S.C. 119 to co-pending provisional patent application No. 61/496,668, filed Jun. 14, 2011, the contents of which are incorporated herein by reference.

### FIELD OF INVENTION

The present invention is directed to a system and method for organizing things (including persons, creatures, objects, thoughts, affairs, circumstances, actions, events, objectives, tasks, statements, attitudes, emotions, symbols, ideas, and information) in relation to time and location, and in one embodiment to a system and method for collaborative documenting, searching, networking, and connecting, and in another embodiment to a system and method for documenting and searching in a non-collaborative manner. Both of these embodiments may be used for personal, social, familial, professional, or other purposes. The present invention is referred to herein as an Event Networking system, which encompasses events, persons, objects, activities, emotions, interests, etc. that can be organized in relation to a time and a location.

In addition to this system's and method's ability to function as an Event Networking system, it also has the ability to function and operate independently as a next-generation internetworked system, having components including, but not limited to: search engines; social networking systems; blogging systems; genealogy systems; dating systems; classified listings; venues for consumer reviews; a universal timeline; media sources; and historical, statistical, and encyclopedia repositories.

Another embodiment of this invention may include the functions, operations, and data of existing systems—such as, but not limited to, search engines, social networking systems, blogging systems, genealogy systems, dating systems, classified listings, venues for consumer reviews, historical, statistical, and encyclopedia repositories, and media sources—for the purpose of providing to these existing systems the next-generation improvements as described herein.

Yet another embodiment of this invention combines the above embodiments.

### DISCUSSION OF THE BACKGROUND

A number of social and professional networking sites have been developed that are people-centric, in as much as they allow former and current relatives, friends, acquaintances, classmates, professionals, relationship partners, friends of friends, and acquaintances of acquaintances to connect to one another to share posts, photos, and other media. These connections are based on previously existing relationships and relationships that are had in common. Examples of such systems are the FACEBOOK social networking site and the LINKED-IN professional networking site. These systems only facilitate connections between people and do not provide a means of facilitating connections based on shared events, interests, and/or experiences of the past, present, or future.

Search engines have been developed that use text-based indexing and web file attributes (metadata) to structure online data to deliver relevant search results for users. Examples of such systems are Google, Bing, and Yahoo. Even though these text-based search engines can utilize file metadata and multiple keywords and phrases, they are limited in their search abilities because they are not specifically indexing the content of files with separated and standardized data types such as latitude, longitude, classifications, and time. As shown in FIG. 5, these types of search engines employ a periodic indexing, crawling, and caching of web site content that is less conducive to real-time search results.

### DEFINITIONS

The following terms and definitions are used within this application.

“Event Networking” is the online process of Event-based documenting, organizing, searching, networking, communicating, and connecting.

“Xirch” is an arbitrary name for an implementation of a collaborative online Event Networking system such as described herein.

“Entities” are representations of things such as actual people (famous, infamous, or otherwise), objects (e.g., automobile), historic events (e.g., WWII), organizations (e.g., The Red Cross), businesses (e.g., Wal-Mart), or concepts (e.g., Structural Engineering). Entities can be real or fictional (e.g., George Washington or Donald Duck). When a Timeline is created and titled, it becomes an Entity within Xirch.

A “Surrogate Entity” is one that a User creates for anyone or anything else, other than the creation of his or her own Personal Timeline. Some types of surrogate Entities are when a User creates a Timeline Entity for a child; an ancestor; a business; a famous person; an organization; a community; a place; an historic event; a product or invention; a concept; or a fictional person, literary work, or film.

The “Owner” of an Entity is the person, group, or organization that has authority over it. An individual owns the Personal Timeline created to be an autobiography of his or her own life, using his or her own name as the title. An organization such as the WIKIMEDIA FOUNDATION could allow certain editors to create within Xirch various Entity Timelines corresponding to its existing WIKIPEDIA encyclopedia articles. The WIKIMEDIA FOUNDATION would be the official Owner, or the authority over them. Any corporation, group, or person who creates, within a Xirch Account, a surrogate Entity for another real or imaginary person (living or deceased), a business, an object, or an historical event would be the Owner of such an Entity.

A “User” is an individual person who enters information into an Entity's Timeline or who extracts data out of Xirch through a search process.

Each Entity can be associated with a Xirch “Account” that is opened by an Owner, or the Owner's representative, through a Sign-up process.

The term “Event” refers to a Entity submission that is made using Xirch's standard process of designating some combination of separate and different types of identifying characteristics, namely: A) “who,” “what,” “why,” and “how,” descriptors; B) location, or “where” factors; and C) date/time, or “when” factors. As shown in FIG. 1, an Event includes any happening or occurrence that may also be related to a certain Location and/or Time. An Event may be entered using any of the following: (Classifications A+B, Classifications A+B+C, Classifications B+C, Classifications A+C, Classifications A+A (without requiring Classifications B or C, such as A.1+A.2; A.2+A.3+A.4).

“Time” is used as the period or point at which any Event occurs. It is a part of the measuring system used to sequence Events, to compare the duration of Events and the intervals between them, and to quantify rates of change between Events.

The term “Location” is used to identify a terrestrial or extraterrestrial position, or a relative place that is described as a displacement from another site.

“Interfaces” are the graphical representations used by Xirch to display an Entity's Events and information. These may take the form of graphs, reports, charts, maps, and timelines. Interfaces can display Event information chronologically, and provide access to attached materials, additional metadata, and details for each Event.

Personal Timeline, Business Timeline, and Entity Timeline are alternate terms that can be interchanged with the term “Entity.” Tom Smith's life story, titled, “Tom Smith” is an Entity in Xirch, but Tom refers to it as his Personal Timeline. Tom may also be a representative of Dell, assigned to enter that company's history in Xirch on a Business Timeline, an Entity he titles, “Dell.” Additionally, Tom could be interested in telling from his point of view the history of the Civil War and that Entity in Xirch would also have its own titled Timeline.

“Classification Information” for Events are constituted by descriptors such as “who,” “what,” “why,” and “how,” and factors such as “where” and “when.”

When submitting an Event in Xirch, it can be associated with at least one “Category.” This is one of the ways to designate a “who,” “what,” “why,” or “how,” descriptor. Xirch has numerous Categories and sub-categories such as experiences, people, products, services, organizations, emotions (e.g., happy, sad, depressed, or nervous), task difficulty evaluations (e.g., easy, hard, medium), interests, occupations, and activities.

Each Event can have unlimited “Supplemental Data” or Metadata elements attached to it, such as photos, videos, audio files, stories, autobiography chapters, and hyperlinks.

A “Connection” can be made when an Event from one Entity becomes accessible to a second Entity's interfaces, allowing mutual collaboration.

“Following” is defined as a User selecting to track another Entity's Event or the Entity in general. Following is for such purposes as receiving updates, staying informed, information, interest, and viewing-only, and it does not allow collaboration.

A “Merge” is the process of combining one or more Entity's Events into a single interface. This operation may be static or dynamic representations of these Events, and may include all or any subset of each Entity's Events.

When one or more Events are direct descendants or subsequent happenings of another primary (or parent) Event, they can be Linked to indicate this relationship. These “Linked Events” may be structured and displayed hierarchically to indicate the parent/child relationship between the Events for such purposes as searching, Following, and Connecting to related and subsequent Events.

Xirch's “Universal Timeline” is a Xirch-Owned and managed Entity Timeline display that presents everything Users want to submit as Events (barring the fictional and the fantasy) in relation to the real world's or the universe's past, present, or future.

Xirch allows Users to create Timelines with Events and/or supplemental data that require “Membership Access.” Verification is required in order for members to gain access to specific events and/or supplemental data. Membership access may or may not require an access fee, to be determined by the Timeline creator and administrators. These access fees may be charged per use, monthly, or annually. The amount of the access fee is determined by the creator and/or administrators of the Timeline.

### BRIEF DESCRIPTION OF THE DRAWINGS

The following descriptions, given with respect to the attached drawings, may be better understood with reference to the non-limiting examples of the drawings, wherein:

FIG. 1, “Entering an Event,” is an exemplary relational diagram showing the possible combinations of one or more identifying characteristics, of which each of the combinations being applied is assigned to each Event as it is entered. As shown in FIG. 1, an Event includes Classification Information in various combinations of descriptors (“who,” “what,” “why,” and “how”), location-specific factors referencing the “where” of a physical or fictional world, and time-specific factors referencing the “when” of a fixed point in time or a time range.

FIG. 2, “Example Relationships Between Entities and Events,” is a relational diagram showing a number of exemplary relationships between Entities and Events. As shown in FIG. 2, various Entities can be Connected to various Events through their respective User interfaces: some of these Events are shared (through Connections) between the various Entities (e.g., Event B is shared between all three Entities [1, 2, and 3]); some are shared between a more restrictive set of Entities (e.g., Event A is only shared between Entities 1 and 2); and some are not shared (e.g., Event D is currently only accessible to Entity 1).

FIG. 3, “Timeline Interface,” is an exemplary relational diagram showing how Event titles can appear on an Entity's Timeline and how Events can each be viewed in more detail. As shown in FIG. 3, various Events appear on a Timeline as dots (for points in time) and as lines (for ranges in time). Each Event on the Timeline can be “opened” for viewing of the basic Classification Information associated with it, as well as subsidiary information, such as mapping and Supplemental Data.

FIG. 4, “Timeline/Map Interface,” is an exemplary relational diagram that combines what is in FIG. 3 with the Map Interface. The Map Interface that is shown in FIG. 4 demonstrates how an Event is displayed on a map and how it can be “opened” for viewing of the basic Classification Information and Supplemental Data.

FIG. 5, “Search Engine Indexing Methods & Cached Results” is an exemplary relational diagram that illustrates the method by which search engines generally index and rank web content and present the cached results to a user, based upon a text-based search query.

FIG. 6, “Xirch Search Engine Indexing Methods & Real-time Results” is an exemplary relational diagram that illustrates the method by which the Xirch search engine will index Events and content and present the real-time results to a user, based upon a search query that can include more than one data type for its criteria.

FIG. 7, “Search Interface” is an exemplary relational diagram of a User interface that demonstrates how an Event may be searched using multiple criteria.

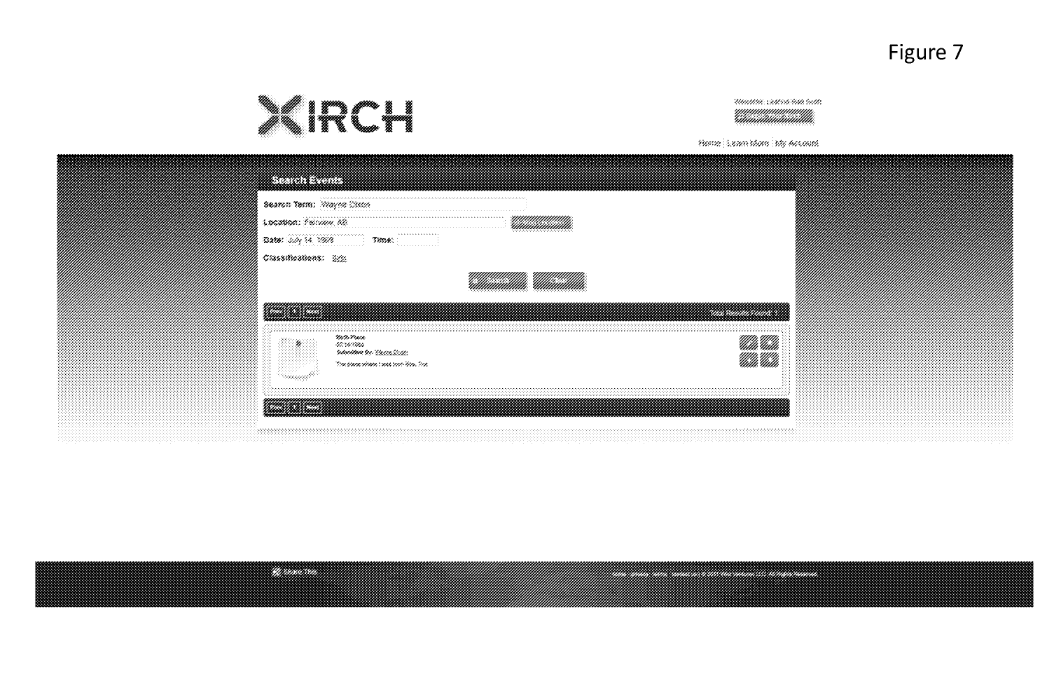

FIG. 8, “Searching for an Event” is a exemplary relational diagram that illustrates the various separate Classifications and data types (text, time, and location) that may be contained in and constitute a Xirch search query for the purposes of identifying similar Events based on multiple criteria, and not only on text based (Classification A) data types.

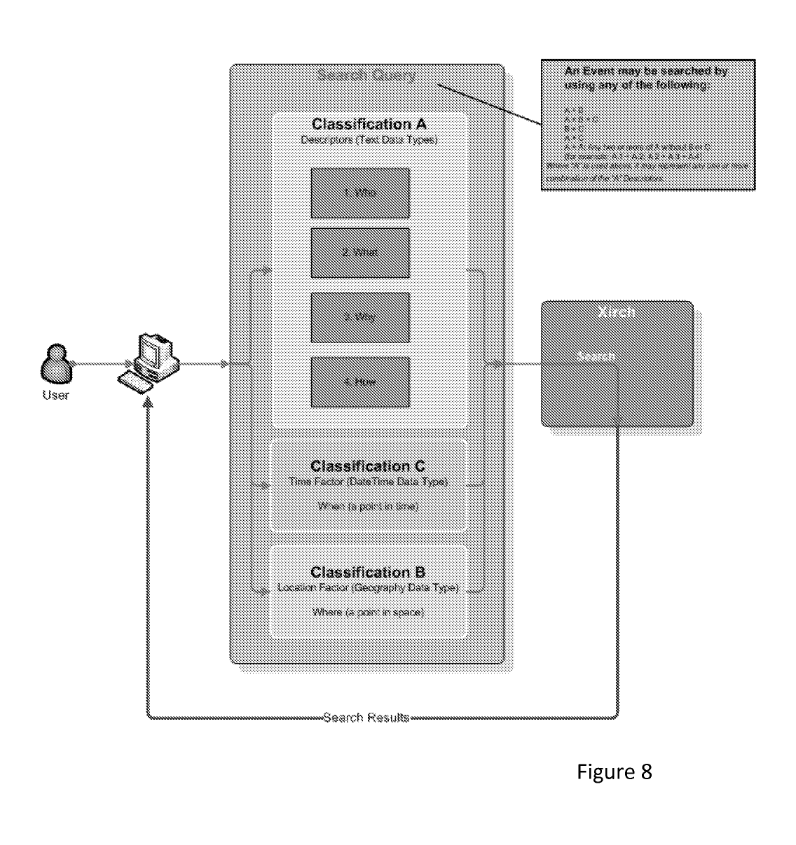

FIG. 9, “Multi-Layer Hierarchy” is an exemplary relational diagram that illustrates the independent Hierarchical structure of Events for each Entity.

### DISCUSSION OF THE PREFERRED EMBODIMENTS

### Real-Time Indexing and Classification

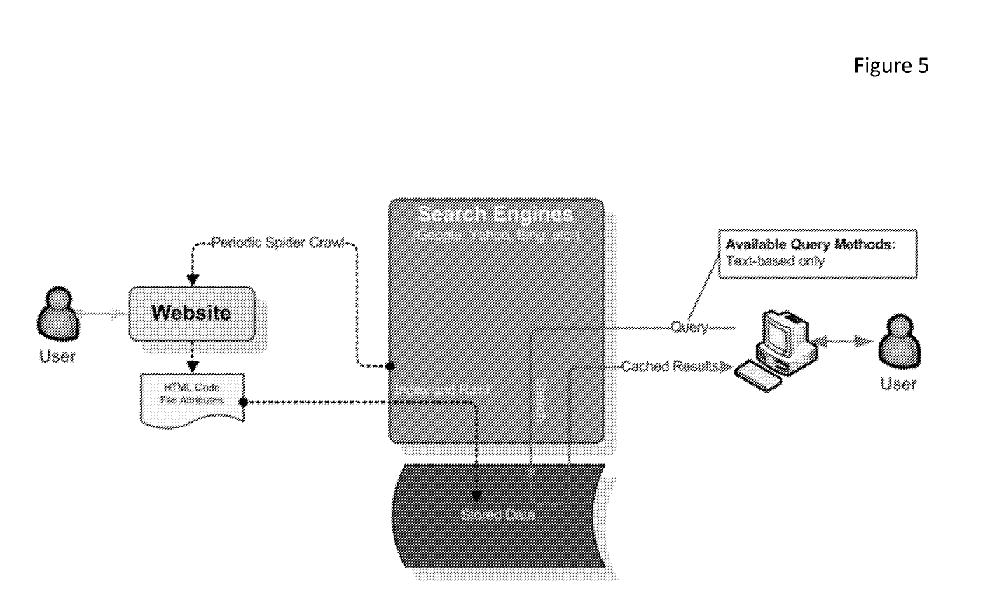

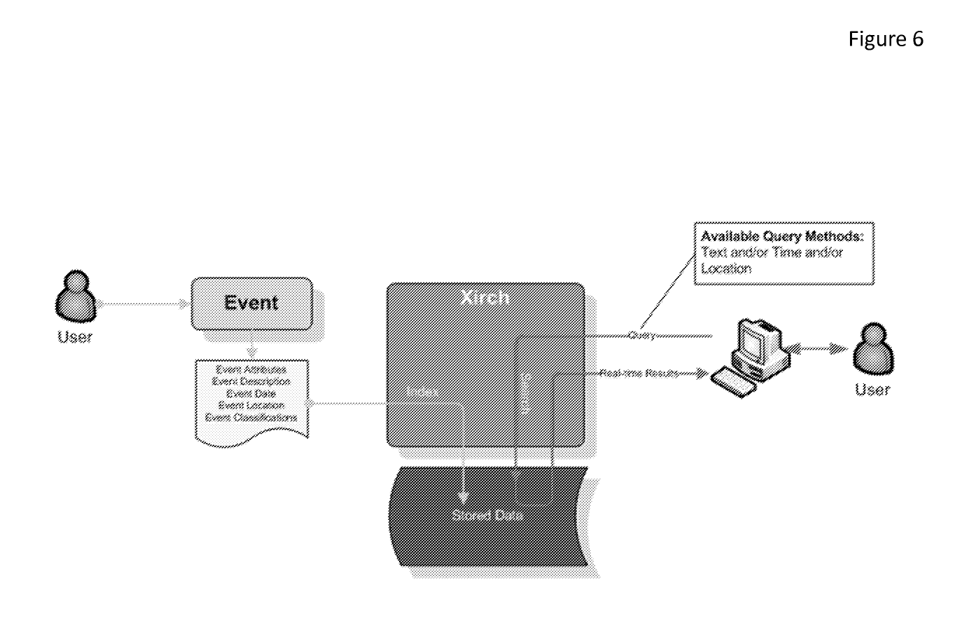

When a User “publicly” enters an Event into Xirch, all other Users have instant access to this information through the search mechanism. With other search engines, the typical method is to create, store, and search a “cached” database of web content. This creates a time differential between the cached version and the live version. Unlike such other systems, there is no waiting for Xirch to perform a scheduled crawling, indexing, and classifying of the Event before it is displayed in searches. As well, when a User enters an Event into Xirch and designates it for sharing with a particular group, all Users in that group have instant access to it through a notification or a search. Also, a User has the instant ability to search for his or her own Events, including those that have been designated as “private.” (See FIGS. 5 and 6.)

### User Account

Each User of Xirch creates an account, as through a sign-up process, and enters basic information such as first and last name, email address, date of birth, gender, and a User-selected password. Various account security settings can be used to designate which account information can be shared and with whom.

### Interface Functionality

Timeline Referencing

The Classification Information system used by Xirch includes “when” factors (that is, date and time). Time can be delineated in any terms available, typically a calendar date and a time of day. “Calendar date” can reference any useful calendar system that would allow the suitable definition of the point in time of an Event. The Gregorian calendar, for instance, is used in most parts of the world and offers a certain practical standardization. However, there may be reason to use other calendars such as a lunar calendar; religion-centric calendars (e.g., Judaic, Islamic, and Hindu); arithmetic and astronomic calendars; fiscal calendars; and others as may be most useful. A method for translating dates between any two calendar formats can be implemented.

“Time of day” can be described in the most useful units, for example, twelve-hour (AM or PM), twenty-four hour (“military” time), or other units. Time units can be small, such as nanoseconds, or large, such as millennia, which are potentially useful when describing a time range. Typical Event times describing “time of day” will usually relate to the local time zone of the Event. A “time range” can also be used in situations where it is useful.

The Timeline Interface can be manipulated to present a large portion of time in a small area of the display, and a small portion of time in a large area of the display.

The Timeline Interface display allows for filtered viewing, which means that a User can view Events on a Personal Timeline in a variety of filtered ways, for example, viewing only the Events from one User-designated folder, or viewing only the Events from a Followed Entity or Event.

Also, the Timeline interface functionality can be used for comparisons between two or more Entity Timelines, which, for example, can be juxtaposed or merged. An example of this would be comparing a grandfather's Personal Timeline with a Timeline for world events.

Location Referencing

The Classification Information system used by Xirch also includes “where” factors (that is, location information). For terrestrial places, location can be described by such means as latitude and longitude coordinates, altitude, legal land descriptions, or street addresses. Extra-terrestrial points in space are most often delineated with the use of the three descriptors, “galactic latitude,” “galactic longitude,” and “distance.”

Location can also be an area, described, for example as “a circle defined by a radius of a certain dimension that is centered on a specific point;” “a rectangular shape defined by key points around its boundary;” or a geographic or political space, such as “continental U.S., west of the Mississippi,” “within the State of Louisiana,” or “on the sunlit side of the moon.”

Location can also be described in three-dimensional ways, such as “x-y-z axial coordinates,” meaning with a descriptor such as latitude and longitude in combination with a vertical coordinate (one that is perpendicular to the plane of the earth's surface), for example, a building floor number, a height or depth above or below sea level, or the altitude in an airplane. For any one x-y coordinate, there can occur multiple Events at various vertical (z-coordinate) positions, such as different building floors, for example.

Location can also be a volume of space, such as the volume of the Holland Tunnel, Mt. Everest, or the sun.

### Privacy Settings for Events and Supplemental Data Items

Each Event, metadata element, and supplemental data item can independently be designated as public, private, or shared with User-selected groups of people, as specified by the User who is entering or managing the Event or supplemental item.

### Mobile Devices

Events can be input both programmatically and by Users on fixed devices (e.g., desktop computers). Events can also be collected and submitted with mobile devices.

### Verification of Owner and User Entities

A system of verifying the Owners, or the Users of Entities, such as law enforcement personnel, famous people, organizations, etc. may be used to reduce impersonations, slander, and other potentially harmful conduct.

### Communication Between Users

Communication opportunities in Xirch (e.g., instant messaging, internal messaging, email, video conferencing, and text messaging) are possible for any two or more Users through system operations such as Connecting, Following, and searching. When Users communicate through a Connected Event, access is given to designated groups or individuals. When a User initiates communications with others, that User specifies which group(s) can have access to those communications.

### Documenting an Individual's Life Experiences

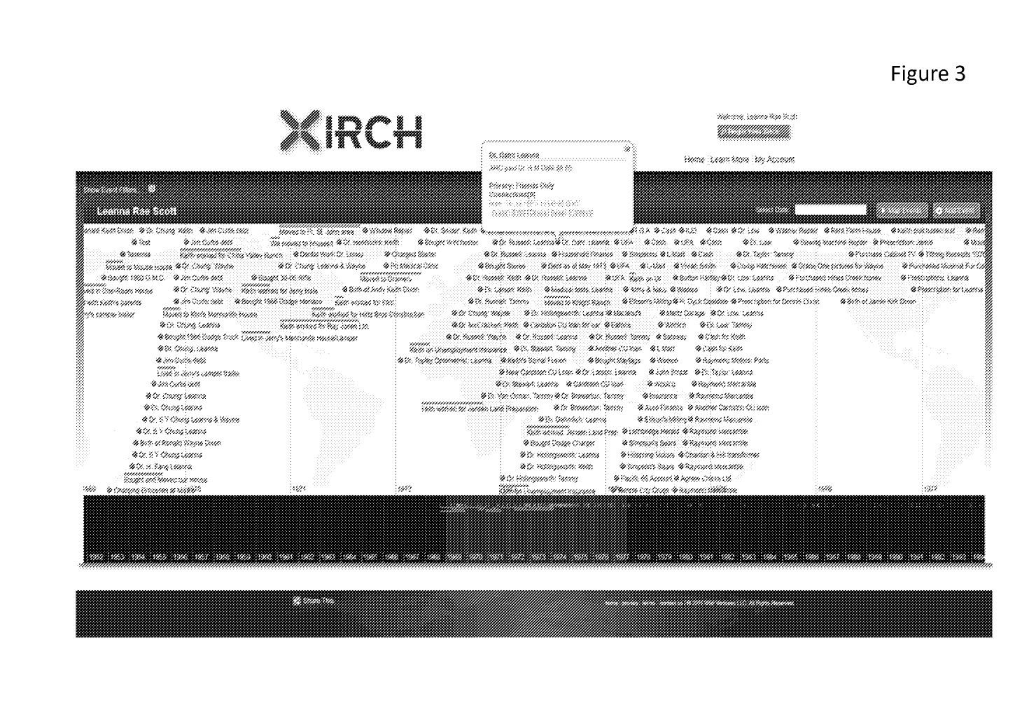

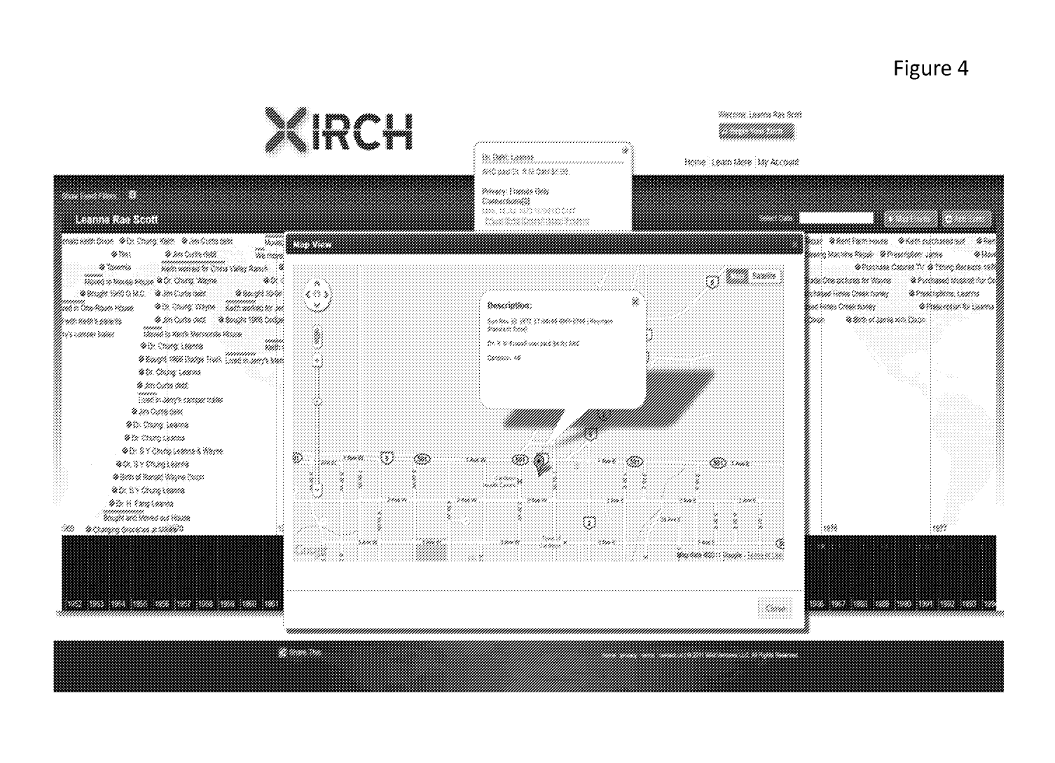

An individual User can initiate a Xirch experience by setting up an Account and starting to enter Events for whichever life experiences he or she wishes to document in a personal Entity file (or Personal Timeline) titled by his or her own name. This can be strictly a personal and private effort, or it can be a collaborative and interactive effort with other Users who are able to contribute. Events for this Entity or Personal Timeline can be entered, displayed, and edited using various interfaces, including Timelines, maps, graphs, and charts (see FIGS. 3 and 4). In the Timeline interface, all Events entered for the Entity or on the Personal Timeline are presented chronologically in a visual representation, with easy access from this interface to accompanying information and supplemental data for each Event.

A User may enter Events on a Personal Timeline, only representing his or her life experiences from birth to the present, and add new Events as time passes. Alternatively, a User could add ancestral or historical Events that precede his or her birth, as well as future Events, such as an anticipated graduation date.

In most people's lives there are elements of greatness and wisdom that are never documented and are typically unknown to others. Xirch provides a previously unavailable platform that facilitates the easy and comprehensive documentation and sharing of lives in many formats (e.g., slide shows, videos, print-on-demand books, scrapbooks, and eBooks). In society these opportunities have been afforded only to those who have achieved frame or notoriety (e.g., biographies, documentaries, films, fan magazines, and news venues), but now such opportunities are extended to all.

These same aspects of documenting an individual's life experiences can be applied to documenting the life of a business, an organization, an historic event, or anything else anyone could wish to document. Examples of some of these kinds of “surrogate” Entities will be given later in this document.

Organizing Events

Users may enter a variety of types of Events, including, but not limited to, schools attended, family occasions, accomplishments, interests, vacations, concerts, medical results, reunions, embarrassing moments, girlfriends/boyfriends, and employment. Xirch facilitates Users' ability to organize a wide variety of types of Events in a number of ways: 1) at the time of entry, Events may be assigned at least one “who,” “what,” “why,” or “how” descriptor from one or more subsets of the system Categories, such as “Experiences, People, Products, Services, Organizations, Emotions or Moods, Task Difficulty Evaluations, Occupations, Interests, and Activities (e.g. One Event might be assigned to additional sub-Categories, such as relationships, concerts, and embarrassment); 2) each Event can be grouped at any time into any number of User-defined hierarchical containers such as folders, sub-folders, and sub-sub-folders. (e.g. One embarrassing Event with a boyfriend that happened at school could be placed into three separate User-named groupings or folders, namely Education, Embarrassing Moments, and Boyfriends.); 3) any Event can be Linked with any one or more subsequent events for the same Entity or Personal Timeline in order to show connection.

Each User who creates a Personal Timeline in order to document his or her life may proceed with entering Events in whatever order makes the most sense to that individual at any given time. Xirch facilitates whatever organizing or documenting style any User prefers. The only type of “order” that needs to be followed, obviously, is that an Event must be entered before supplemental data can be added to it (for example, a photo must be attached to an existing Event). Xirch saves every data submission and potentially allows unlimited editing at any time.

Supplemental Data

Each Event can have unlimited supplemental data attached to it (for example, a User can attach to the associated life Events every photo, video, document, audio file, story, autobiography chapter, hyperlink, or any other type of media he or she has). For each Event, Users can attach comprehensive collections of materials that document or represent any portion of or the entirety of the “who,” “what,” “where,” “when,” “why,” and/or “how” of their lives.

Event Data Values

An Event can include any number of additional metadata elements, with data values and various data type descriptors. These data type descriptors may include but are not limited to: integer/numeric (8, 705.9090, −678.098, 0.9823), string (“Rainy,” “Ten,” “Salt Lake City,” “Always,” “Euphoria,” “Disagree”, “Easy”), Boolean (true, false, yes, no), currency ($10.00 USD, $149.99 CAD, [symbol] 59.89, £ 789.00), temperature (102° F., −30° C.), volume/capacity (12 cm³, 4 L, 10 m³, 12 qt, 3 tsp), and any other forms of height, length, distance, depth, weight, or speed measurements (14 in., 8 g, 156 lb., 59 mph, 8 MB, 1,500 ha, 79 km, 30 yd, 90 Hz). Some of these may be applied as a customizable rating or evaluation method, such as a numeric scale representing the range between “strongly agree” and “strongly disagree”. The inclusion of metadata with Events provides a means to plot, query, and view data values over time in such interfaces as graphs, reports, charts, maps, and timelines.

For example, Lyle has worked as a sales representative for various companies throughout his career and has traveled extensively throughout North America. Lyle may add each travel destination as an Event in his Personal Timeline, along with the associated distance and travel costs as additional metadata elements. He later extrapolates partial or complete sets of data into maps, timelines, reports, graphs, and/or charts, such as the complete list of destinations he has traveled to and when, as well as the cumulative distance and associated travel expenses. He is able to tabulate distances traveled, expenses within any given period of time, or identify the year he traveled the most. Importantly, useful patterns that may go otherwise unrecognized can emerge to make future trips more productive.

Filtering Data for Viewing

A User may wish to view data from his or her own Entity in a variety of filtered ways, such as, but not limited to: viewing on the Timeline and/or Map Interface only the Events from a particular folder, such as “Employment,” “Dance Contests,” “Places I've Lived,” or “Vacations;” viewing in a chart interface only the recorded values of body weight or Body Mass Index for the entire documented time span or for a particular range of time; viewing on a Map/graph interface the various costs of various vacations throughout a particular range of time; and viewing on a map, list, and/or Timeline interface just the updates for all of the Events or Entities, or specific Events or Entities that are being Followed.

Dynamic Displays

Events, metadata elements, and supplemental data can be presented in dynamic displays (showing objects in motion, continuous change, activity, animation, time-lapse, or progress). Examples of dynamic displays include: 1) the chronological and sequential charting or mapping of a road-trip route or points visited, presented in a variety of formats, including slide shows, animations or mini movies that can be played, or presented in successive-frame time-lapse fashion in relation to the mapped vacation route; 2) the time-lapsed display of an accumulation of a child's yearly birthday images in relation to the dates; and 3) a graph, chart, or time-lapse presentation of recorded daily (or hourly) emotional states over a particular period of time.

### Aggregated Information Viewing

To improve the User experience, the option can be provided for search results and supplemental data to be organized into an aggregate view. Search results can also be viewed by means of consecutive navigation. These features eliminate the requirement to return to the initial list of search results to separately open and view each item.

### Event Networking

By utilizing Event-based networking, the system as described herein provides the opportunity for Users with similar or shared experiences and/or interests, to interact, connect, reconnect, collaborate, and socialize. Unlike systems that are User-centric (that is, people networks or social networking sites), an Event-based system as described herein allows people with one or more common experiences or interests who have not previously met (and who may have no friendships in common) to find each other and participate in a social, cooperative, or collaborative environment. For example, people all over the world, most of whom have never met each other, can remember when and where they were during particular historical events (or where they were when they heard about certain historical events). While those disparate people may have never met each other, they may still have common experiences that can connect them in this Event Network and for which they may wish to memorialize their combined individual recollections.

This Event-based networking system also allows Users who have prior relationships (such as family and extended family members) to collaborate on entering Events that are commonly remembered between them, as well as attaching the supplemental data of each person in the group (such as individuals' photos of joint family events). Groups of people with or without pre-existing relationships are able to collect and incorporate materials and collaborative input from additional sources (e.g., relatives, friends, news, and business Entities); create, preserve, publish, and export someone or something's life story; and selectively share it with other Users.

Other collaborative aspects and scenarios of such a system will be described in greater detail below.

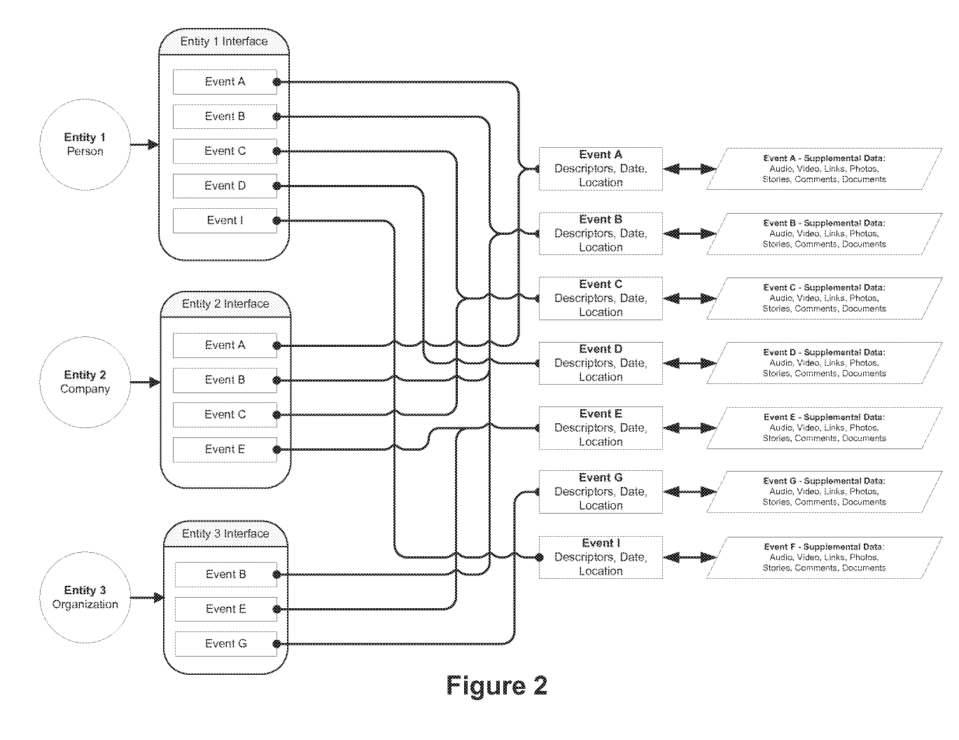

Classification Information (namely one or more of the “who,” “what,” “why,” and “how,” descriptors), or one or more of the “where” and “when” factors may be utilized in searching for an Event (See FIG. 2, “Searching for an Event”). When a search is performed, one or more Classification Information items are submitted so as to find Events and/or Entity Timelines that match them and which have been User-designated for the searcher's availability (that is, public for everyone, or for a specific group of Users that the searcher is in). The more Classification Information that is submitted, the narrower or more focused the search results are. From this search process, matching results may be displayed to the searcher in various interfaces, such as a list, Timeline, map, graph, or chart. From the displayed results, the searcher can do many things, including: view other Entity's Events and/or Timelines (including metadata and supplemental data in all interfaces such as charts, graphs, and maps); compare one Event with another or one Entity's Timeline with another's; Follow Events or Entity Timelines so as to keep informed about them; communicate with other Users; or Connect to Events and Entity Timelines (subject to that User's approval), to import that Event or Entity Timeline (including supplemental data) into the searcher's own Personal Timeline, if one exists.

Notifications

During the process of a User entering Classification Information about an Event, the system notifies this User, through search results (e.g., that automatically appear at the bottom of the screen) of any and all similar Events that have already been entered into the system. This automatic list of search results includes similar Events entered: 1) by this same User in his or her own Entity Timeline; 2) by other Users in other Entities; and 3) autonomously by the system when it “crawls” external information sources or websites that collaboratively allow data to be imported by the system. This list of search results for similar Events—that automatically appears when a User is entering an Event—dynamically changes each time an additional piece of Classification Information is entered into one of the data fields, thus allowing the system to increasingly be more specific in its search.

Users are also notified by the system when other Users wish to Connect to or Follow their Events or Entity, or view, update, or add supplemental data to them. Some optional notifications are also possible: a User can select to be notified by the system in the future whenever another User enters a similar Event; and a User can choose to follow another Entity or Entity's Events, being notified when there are updates (Users could choose to follow news stories, famous people, government policies, friends, and/or family members, etc).

Users can receive system notifications by various methods (e.g., by using a Xirch interface, cell phone, email, or text message) in customizable presentation formats. These notifications can be generated from pre-selected search criteria at User-specified time intervals.

All of these system notifications provide opportunities for Users to find each other and connect, collaborate, and communicate with each other based on common Events.

Following are five examples of how notifications are used within Xirch.

Joan enters the Event of her child's birth onto her Personal Timeline. She submits the date/time, location, description, category, and supplemental media. Her husband, Samuel starts to enter the same child's birth when creating his own Personal Timeline and is automatically notified of Joan's existing birth entry for his viewing. Samuel then has the option to abandon his own entry in progress and Connect with Joan's birth Event, then having it also exist on his Personal Timeline (along with any accompanying meta data or supplemental data that she has designated for sharing). Joan will be notified if Samuel Connects to her Event. Based upon the security settings Joan has set for the Event, Samuel now has the ability to add his own comments, supplemental media, and stories (from his perspective) to this shared Event.

Two previously unacquainted train passengers glimpse each other across the station platform, each in a different train, just as one of their trains is leaving the station. One or both of them may want to follow up on that glimpse. Xirch allows them to enter as an Event in their Personal Timelines the date and time, location, description of the encounter, and a request for Connection or communication. If both parties participate in this process, the first one to enter the Event can receive a User-requested notification when the second one enters the Event, seeks a Connection, or communicates. The second person, while entering the Event, receives an automatic notification of the first-entered similar Event. These two can decide to make a Connection or communicate, as desired. Without Xirch, such an easy ability for passing strangers to find each other would not be possible.

Chan drives by a traffic accident and after hearing on the news of a fatality, she wants more information about it directly from people who are affected by it. A relative of the victim of the accident, four witnesses, a late-arriving bystander, and three news sources have already entered the accident as Events on their respective Entity Timelines by the time Chan begins to enter it on her own. She receives notification of their entries automatically as she is entering hers. She chooses which of these she wishes to Connect to and Follow. She also makes a selection for the system to notify her of additional Event entries for this same accident. She hopes to read what the perpetrator of the accident, reportedly a 20-year-old man under the influence, has to say.

Rose, who lives in London, England, hears of a wildfire that burned through her home town of Slave Lake, Alberta, Canada. In Xirch, she researches this topic. Through Following, Connecting, and requesting notification of ongoing or new coverage of the topic, she receives more information, including details of the complete devastation toll, success/tragedy stories, re-building plans, and research results of the cause of the fire (all with media and hyperlinks attached). With traditional social networking systems, Rose can only receive this information from sources and individuals she is already familiar with, if such information happens to be available through them. Uniquely, Xirch provides Rose with further information from Users who are mutually, exclusively, and only united by this topic and associated Events through Xirch.

After arriving home from his day at the beach with his family, Ramon notices his cooler is missing from the back of his trailer. In horror, he then remembers that he foolishly left his wallet, with cash and credit cards, in the cooler. His phone number is not in his wallet, and neither is his new address, so no one can get hold of him that way, if they were to try. Ramon panics and is about to cancel all of his credit cards, when he thinks of Xirch. With hopes that someone honest and aware picked up the cooler, he quickly starts documenting the Event in his Personal Timeline, almost instantly receiving an automatic notification that a man by the name of John Barry had just entered an Event on his own Personal Timeline, stating that he'd found a cooler belonging to Ramon Ramirez, and giving the location and time. Ramon Connects with John's Event and messages him. Ramon retrieves his cooler and wallet, and offers John a reward. John is not interested in the reward, but after their friendly conversation the men decide to stay in touch through Xirch.

Hierarchical Connections Between Events

Events can be Connected hierarchically. For example, eighty Users otherwise unassociated with each other enter Events publicly in their Personal Timelines based on their experiences of attending Chelsea Handler's Stand-Up Comedy shows in various cities on various dates. Chelsea Handler can create an Entity Timeline for her comedy show tour and can potentially Connect with any or all of these eighty Users' Events, importing their data, metadata, and supplemental data into her Entity Timeline. Likewise, another User could create a “Comedy Show Tours” Entity Timeline and Connect to Chelsea Handler's and other comedians' Entity Timelines. Yet another User could create an Entity Timeline for all “Entertainment Tours,” and the process can be repeated for any number of hierarchical levels.

### Surrogate Entities

The above processes are not limited to an existing person, or User, creating his or her own Personal Timeline. Any User, through a Xirch Account, can also create Surrogate Entities for anyone or anything else, including a child; an ancestor; a business; a famous person; an organization; a community; a place; an historic event; a product or invention; a concept; or a fictional person, literary work, or film.

For example, a User (the Xirch-Verified author or publisher, or a non-verified person) could create an Entity for the HARRY POTTER character, the HARRY POTTER series of books or films, or both. The entire cast of characters and the series of events from the books or the films could be placed as Events on the Entities' Timelines. Any number of “HARRY POTTER” Timelines could be compared to each other. Such Surrogate Entities could even be created in a partial, promotional way for fictional works, prior to their release dates.

As another example, the WIKIMEDIA FOUNDATION could open a Xirch account and incorporate their numerous existing Deepwater Horizon articles (with all accompanying hyperlinks, source references, etc.) into one or more Entity Timelines. Their entries could maintain their company's standards of neutrality, factuality, and reliability. BRITISH PETROLEUM could create its own version of the Deepwater Horizon Timeline. Any interested media company, network, or personality could do the same, entering just their own coverage of the topic, or they could allow collaboration such as added coverage from other media entities and reader comments. All interested parties following their own sets of rules could singly or in collaboration set up their own versions of an Entity Timeline for Deepwater Horizon, even to the point of merging all available material from every source. When anyone does a search relating to Deepwater Horizon, the results will disclose the Owner of each version of the Timeline and the reader will be able to choose from whose perspective to view the material.

Any organization, such as the WIKIMEDIA FOUNDATION or MSNBC, upon entering their own material into Xirch Entity Timelines, transitions from being just an online encyclopedia or news agency into also being part of an Event-Networking system (to whatever extent they wish). Also, having their material included in Xirch facilitates more accurate, relevant, timely, and focused search results for their readers because of the nature of Xirch's independent entry data fields.

In another example, Harold, as the Xirch-Verified concert manager for the band, “LADY ANTEBELLUM,” creates a Surrogate Entity Timeline for the group and uses it in a number of ways: to enlighten fans about its beginnings, progress, intentions, CD releases, upcoming concert dates, and such; to share its photos, video, and audio clips with fans; to show mapped representations of its concert tours and other details; and to facilitate Connections and collaborations with fans and other performing artists. The band's information from their website, social networking sites, and fan sites can be consolidated into this Entity Timeline, which allows fans and others to incorporate and preserve portions of it into their own Personal Entities through the process of Following. Following allows fans to access, for viewing purposes only, the band's Events in their own Interfaces. However, Connections with any Events that the band wishes to allow, will permit fans to collaborate by submitting their own photos and reviews, sharing opinions, completing polls, donating to causes, etc. User-submitted collaborative content can be made public or kept private, as the band chooses.

The Xirch-Verified director of a charity creates an Entity for the charitable organization in order to: increase public awareness about its operations; denote programs, past missions, training events, announcements, donations, and budgetary and other reports on a Timeline interface, a Map interface, and chart and graph interfaces; Connect with volunteers, supporters, donors, patients, and international leaders and ambassadors; provide a venue for success stories (with photos and videos) to be shared with the public; and share management and other details with designated groups of Users, such as the management team.

Designated employees from various locations of Rubio's Fresh Mexican Grill, a restaurant chain, create Events in its Business Entity Timeline. Some Events, such as business history details, future promotions, product information and images, product and service offerings, location listing, contact information, and customer testimonials are entered with a “public” designation. Customers can Follow an Event of this Entity in order to receive such things as updates, coupons, news, notifications of events, and product releases. Other Events, such as training sessions, are entered with an “employee” group designation. And yet other Events, such as day-to-day company operations, project management data, and employee productivity records, are entered with a “management” group designation.

### Enhanced Interconnectivity

Joan opens a Xirch account, and in her basic profile she indicates that she is looking for a marriage partner who meets particular criteria. She then enters various Events “publicly” that indicate numerous things about herself that she wishes to have known by any potential daters (such as things that indicate her interests and hobbies). This allows Joan the ability to search for potential dating partners based on her general criteria, such as non-smoking, non-drinking, between 50 and 55 years of age, interested in a long-term relationship, just like she can on other dating sites. But additionally, Xirch allows Joan to be found by potential dating partners primarily based on any not-so-general criteria, such as an interest in raising thoroughbred horses, stock car racing, mountain climbing, playing the piano, being into high fashion, raising honey bees, or any other text information. Joan can also search for potential dating partners based on customizable combinations of general (such as social drinker, 40-50 years old, within 50 mile radius, secondary education, looking for long-term relationship) and not-so-general criteria (such as family oriented, loves dancing, fluent in American Sign Language, and wants a working wife). Such customized searches can speed up the process of finding a truly compatible long-term partner.

Law enforcement also has opportunities to use Xirch in beneficial ways. For example, when a robbery takes place at a convenience store, Xirch-verified Detective Denton enters the Event in the local police department's Entity, building an auto-query process that will notify his agency of any Events entered by other Users that may indicate a connection to investigate. Officers at the scene of the crime do their usual questioning of potential witnesses, including the customers across the street at a restaurant. Later that evening, Maria, an attendee of a birthday party at the restaurant (who left just after the robbery, but before the police arrived) enters her experience of the party into Xirch. The auto-query process (based on the time and location) alerts the police department of a possible connection. Detective Denton privately messages this potential witness, seeking any information she can give about the crime. Maria is able to give the detective a better description than anyone else has so far of a car that sped away from the convenience store as she was leaving the restaurant.

Also, Francisco (a young man who believes he saw two men with handguns hopping into a car as he slowed down to turn into the convenience store and then changed his mind) searches in Xirch to see if the police have reported a crime occurring there. He messages the police department contact, Detective Denton, anonymously to share descriptions about the men and their vehicle that corroborate and elaborate on Maria's description, helping the police find the criminals. This same methodology is especially valuable for solving past crimes and cold cases.

Other than law enforcement agencies gaining information from the public about criminal behaviors, there would also be other benefits to them entering criminal activities as Events in Xirch. Some of these benefits include: the public could Follow a crime story and its updates from a more direct source than the media; anyone could Follow a particular type of crime in a particular jurisdiction or potentially across the country, continent, or world; statisticians could have direct access to this valuable information; Users could sign up for automatic notifications of crimes, neighborhood watches, Amber alerts, etc.; and Users (including victims and witnesses) could participate in forums about crime in general or specific crimes. Xirch provides opportunities to ascertain details that would be otherwise unavailable.

### Event Networking

Xirch can be used as an Event-Networking system that facilitates connections between strangers based on shared Events, interests, goals, and/or experiences of the past, present, or future. For example, Yalena has just started following an Atkins diet and is interested in networking with other people who are doing the same. When she enters her diet information as an Event on her Personal Timeline, she can then view similar or matching “public” entries from other people, in the order of most relevant to least relevant. Yalena can choose to Follow or Connect to however many of these Events or Entities, including their Linked Events, she would like to. She can choose to communicate with some of them, designate them as “friends,” or organize them into one or more groups of associates. They can challenge or motivate each other and exchange tips, ideas, advice, recipes, data, before and after photos, etc. Some of them could unite in a weight loss contest. They could individually chart such things as their own weight; exercise types, amounts, and equipment used; trainers' recommendations; comments; photos, video, or audio files; carbohydrate or calorie intake; or medical test results. Yalena could share as much or as little of this as she wants with some of her new acquaintances.

Finding People Based on Past, Present, and Future Events

Johanna is planning a 50^{th} wedding anniversary celebration for her parents and wants to find additional photos and stories relating to them. With her parents' help, Johanna enters the main Events of their lives in Personal Timelines for them, including the places they've lived, worked, gained education, and vacationed and the primary people they've known as family members, friends, coworkers, classmates, club members, and bosses. As she enters these details (times, locations, and other descriptors) as Events, Johanna pays attention to the automatic results that indicate a number of people who may have had relationships with her parents. She messages these people and finds that some of them were a part of her parents' lives and do have stories and pictures to share. She Connects to their Events and begins to collaborate with them on her parents' developing Timeline. Johanna also indicates that she would like Xirch notifications as other Users enter Events in the future that “match” any of her parents' Events.

Johanna also uses Xirch to post information about the upcoming 50^{th} anniversary celebration Event, with an open invitation to all those interested and a list of the people her parents would like to see there. Johanna posts related announcements, shares supplemental data, maps the location of the celebration, and asks for R.S.V.P.s. In the months ahead, as the date for the anniversary party approaches, Johanna is notified of other User's newly entered Events in Xirch that indicate possible “matches” to Events on her parents' Timelines. Johanna communicates with these Users, one of whom is a daughter of a “long lost” friend of her father's. (That daughter had entered a story which mentioned Johanna's father.) Some of these Users have supplemental data to contribute to her parents' developing Timeline. They begin conversing with her parents and plan to attend the anniversary party. Through the collaborative properties of Xirch, Johanna was enabled to find people and information from her parents' pasts (based on Events, dates, and places) that could not have been as readily found through traditional methods.

Barry would like to find the strangers who came upon him early in the morning of Jul. 5, 1993 as he lay on the Na'Pali Coast mountain hiking trail in Kauai, Hi. with broken ribs from his fall in the dark the evening before. These strangers gave him some painkillers, much of their precious water, and stayed with him until the helicopter rescue off the side of the mountain was complete. Barry would like to thank these strangers, update them on his complete recovery, and see if they have any pictures of the rescue. Barry enters his version of the Event in his Personal Timeline and chooses to be notified if anyone else enters a similar Event. Ten months later, Josh, the young man who gave Barry much of his water that day, enters his account of the same incident while documenting his Hawaii vacation, and Barry's Event comes up at the top of Josh's list of similar Events. Josh Connects with Barry, communicates with him, and they share photos and stories, including that Josh ran out of water on his 23-mile hike that day, was given water-purification tablets by some other strangers, and also didn't finish his hike until after dark. Josh communicates with others who were in his hiking party that day and they all add their photos and recollections of the incident. Barry's daughter, who had gone down the mountain to summon help for him that morning, and the helicopter pilot and paramedics, who continue to rescue people off the same mountain trail, ultimately join in the online collaboration, adding their stories.

Whitney attends the nursing program at a university in Phoenix. As she documents this experience in her Personal Timeline, she looks at the automatic list of similar Events and finds a number of other people who are enrolled in or have completed nursing programs, some at her university, and some at other universities in different cities. She decides to Connect with a number of them for the purpose of gaining online friends, information, advice, and tips with regards to assignments, projects, instructors, etc.

### Consumer Research

One type of consumer research that can be done within Xirch is for a User to access the product reviews of other Users. Users can enter “publicly” as Events on their Personal Timelines any positive, negative, or neutral experiences they have concerning products or services. (They can also do this in an anonymous, but more formal or official “product/service review” kind of way, by using a Xirch-supplied User-associated encrypted identifier that is displayed alongside their reviews. This method helps readers of the reviews identify any patterns of abuse.) Other Users can access in “real time” these authentic, unsolicited- and uncensored-by-the-manufacturer-or-service-company “reviews” to find information they are looking for, such as what to do about a particular product issue or where to go for the best service. One example of this kind of research would be for Arianna to search for “good Italian restaurants” in “Manhattan” within “the past three months.” The results of her search would be a mixture of Users' descriptions within their normal Events on their Personal Timelines; Business Timeline Event entries of Italian restaurants describing their offerings, including coupons; and the more formal reviews submitted by Users.

Amalgamation of Data from Existing Systems Into Xirch

Data from existing systems can be amalgamated into Xirch. Xirch provides unique functions and benefits to business across any number of industries. Businesses can access Xirch through methods such as API interfaces, websites, or dedicated software, allowing external systems to realize the benefits and enhanced capabilities of Event Networking.

Newsfeeds

Various newsfeeds (e.g., from news organizations or different agencies) can be submitted as Events into Xirch. Users can then perform searches based on Classification information, such as time, location, or other descriptors, for those Events. Users can compare news stories from different agencies. Xirch's ability to clearly display news events on a timeline or map, makes reviewing them easier and more rewarding. Patterns can be seen that would not be discernable otherwise. Users can see the differences and discrepancies between the news sources.

### Classified Listings

Xirch can function as a universal classified listing source, combining Xirch-originated entries with all collaborating external classified listings, such as Craigslist. Any collaborating external classified listings would submit their entries into Xirch using the multiple-data-field format of Xirch. This would allow the external entries to be searchable within Xirch, in Xirch search-engine format. Such a universal classified listing within Xirch, in combination with other Xirch concepts, would facilitate numerous improvements in classifieds, for example: the automatic mapping of all garage sales within a specified area for a particular date; the ability to have a collaborative source for classifieds; and the ability for potential employers to verify potential employees' credentials against lists of alumni from schools.

Developing Websites within Xirch

Resources such as web pages (both internal and external to the system) that are indexed using the Xirch classification system (descriptors, categories, topics, keywords, locations, and times) provide enhanced searching capabilities and interconnectivity. Resources entered directly into the Xirch system are available and searchable immediately and do not require a crawling, indexing, and ranking process as is common with existing search engines. Therefore, this type of search offers the most relevant and current information. (See FIG. 6.)

As an alternative, a web developer may include Xirch-formatted metadata, such as meta tags, on a webpage. A process of crawling and indexing such external resources with the same classification system may also be implemented to provide similar searching capabilities, however this would not provide real-time results. (See FIG. 5.)

### Xirch as Licensed Software (Not Online)

The Xirch fields of invention can be offered to individuals and organizations as a non-Internet-based, privately licensed software package for use in corporate intranets and data management systems. Although Xirch online offers the designation of “private” or “group” for each Event entered and each piece of media attached to it, as well as offers “private” or “group” designations for entire Entities, some Users may still wish to have added security, absolute privacy, and full control over their Xirch experience by not accessing it online. The enhanced functionality that Xirch brings to the organizing and documenting of all kinds of material for businesses and individuals is likely to increase the amount of it that is done and therefore may also increase privacy concerns. For example, in the rewarding experience of using Xirch to document her life, a User could feel compelled to also document portions of her life that she has never disclosed to anyone and has absolutely no wish to reveal until after her death. This User could choose to complete her Personal Timeline on a private copy of Xirch and give instructions in her will for her children to gain access to it after her death.

Using Xirch's preferred embodiments in an isolated software package allows organizations and individuals to enhance their existing processes through documenting and searching that is based upon “who,” “what,” “how,” and “why” descriptors and “where” and “when” factors instead of just text-based entries and searches. A system that documents and searches Events utilizing these separate data types and fields, instead of just text-based keywords and categories, is a search engine that more accurately discovers Events directly related to a specific Time and Location.

### TECHNICAL DETAILS

The system as described herein can be built with special purpose hardware (e.g., an application specific integrated circuit [ASIC]), computer code read from at least one computer memory for controlling at least one processor (e.g., a microprocessor or a system-on-a-chip), or a combination of the two. The system may further use at least one communications adapter (e.g., Ethernet, wireless (such as the 802.11 family of wireless adapters, WiMax, cellular, infrared, ZigBee), ATM, fibre channel, token ring) communicating using at least one packet-based communications protocol (e.g., TCP/IP, UDP/IP, Reliable Datagram protocol) for interacting with the Users of the system (as well as additional data sources). The computer code may be read from a non-volatile storage device (e.g., a hard disk drive or a solid state drive) into a random access storage device (e.g., RAM) for execution by at least one processor.

In order to facilitate programmatic searching and addition of Events, the system may utilize a structured data language (e.g., XML) that can describe the information to be added in a flexible and extensible fashion. For example, Events can be stored using the exemplary structure below.

<EventsList>

<Event id=“3a0dd64e-2b90-4135-8c5f-031da08b3939”>

<WhoElementList>

<who id=“9eed536b-1b68-4dda-80ec-38d51d922cd9”>

<lastName>Dixon</lastName>
<firstName>Wayne</firstName>

</who>
<who id=“0616d0e8-a88b-4a55-b9c1-25f0d1ff3fa1”>
</who>

</WhoElementList>
<WhatElementList>

<description><![CDATA[ ... ]]></description>
<category>389</category>
<category>765</category>
<category>78</category>

</WhatElementList>
<WhyElementList>

<description><![CDATA[ ... ]]></description>

</WhyElementList>
<HowElementList>

<description><![CDATA[ ... ]]></description>

</HowElementList>
<Where>

<location id=“1” type=“terrestrial”>

<address><![CDATA[ ... ]]></address>
<city> ... </city>
<state> ... </state>
<country>United States</country>
<postalCode>56793</postalCode>
<latitude>55.173951578257690</latitude>
<longitude>−118.785572380859380</longitude>
<altitude> ... </altitude>

</location>
<location id=“2” type=“galactic”>

<latitude>+0 deg, 44 min</latitude>
<longitude>+315 deg, 49 min</longitude>
<distance>4.3452 lightyears</distance>

</location>

</Where>
<When>

<startDateTime timezone=“−6”>5/31/2011
7:36:29 PM</startDateTime>
<endDateTime timezone=“−6”>5/31/2011
9:00:00 PM</endDateTime>

</When>
<values>

<value id=“1” datatype=“numeric”>

<![CDATA[45]]>

</value>
<value id=“2” datatype=“temperatureF”>

<![CDATA[95]]>

</value>

</values>

</Event>

</EventsList>

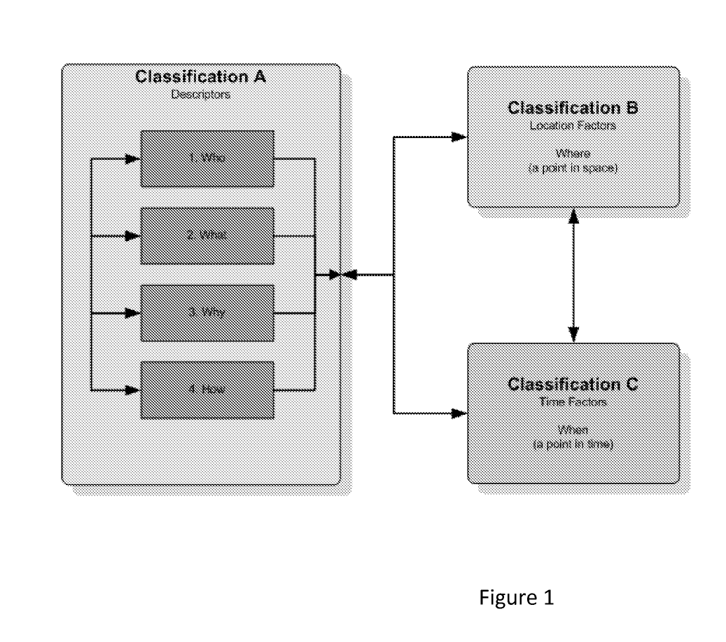

As can be seen from the list-based structures and from FIG. 1, one of ordinary skill in the art would understand that the number of elements in each portion of the Classification information is not intended to be limiting, nor is the number of relationships that can be made between Events and commonalities between descriptors and factors. Exemplary groupings of Classification information for Events are shown below for illustrative purposes, without limiting the scope of the invention, where Classification A=Descriptors (What [A.1], Who [A.2], Why [A.3], How [A.4]), Classification B=Location-specific information (Where), and Classification C=time-specific information (When).
Any one or more descriptors (Classification A [What {A.1}, Who {A.2}, Why {A.3}, How {A.4}]) combined with location (Classification B [Where]). (Example: A.2+B)
Any one or more descriptors (Classification A [What {A.1}, Who {A.2}, Why {A.3}, How {A.4}]) combined with date/time (Classification C [When]). (Example: A.4+C)
Any one or more descriptors (Classification A [What {A.1}, Who {A.2}, Why {A.3}, How {A.4}]) combined with location (Classification B [Where]) and date/time (Classification C [When]). (Example: A.3+B+C)
Any combination of two or more descriptors (Classification A [What {A.1}, Who {A.2}, Why {A.3}, How {A.4}]). (Example: A.1+A.3)
A combination of location (Classification B [Where]) and date/time (Classification C [When]). (Example: B+C)

By utilizing a typed data structure such as the structure shown above, a number of data processing tools (e.g., C#/LINQ) can be utilized by the system to perform complex queries without the need for complicated code. For example, a query could be generated to find all Events with a particular last name as part of the “WhoElementList” where the element corresponds to information relating to a particular city and/or a particular time (or time range).

While the above structure shows an Event and lists of XML elements contained within a single EventsList, alternative data structures are also possible. For example, additional data about an XML element (e.g., another person present at an event) can be virtually added to the element without having to update the original data record by referencing the element to be added and providing the additional information. Such a configuration may be desirable when a system needs to be able to track when changes were made, and by whom. Such a configuration also allows for “undoing” of changes by deleting the additional information added to an element. An exemplary SupplementalEventList referencing the EventsList shown above (i.e., where the SupplementalEventsList child item “Event” and the original EventsList child item “Event” have the same XML id Attribute) could be defined as follows:

<SupplementalEventsList>

<Event id=“3a0dd64e-2b90-4135-8c5f-031da08b3939”>

<WhoElementList>

<who id=“9eed536b-1b68-4dda-80ec-38d51d922cd9”>

<lastName>Dixon</lastName>
<firstName>Wayne</firstName>

</who>
<who id=“19558cfa-5eb3-4d91-b8ba-fd145b33cffc ”>

<lastName>[New Person1 Last Name]</lastName>
<firstName>[New Person1 First Name]</firstName>

</who>

</WhoElementList>

</Event>

</SupplementalEventsList >

For each of the Events stored by the system, the system can additionally store information about which Users are to be contacted when an Event or a specified portion of an Event has been viewed, updated, or supplemented. For example, when a User (Katia) is hoping to reconnect with someone that she met on vacation, she creates enough information about the vacation (e.g., location, time, activities performed, characteristics about people who were met) and registers a request to be notified when the information is supplemented. Later, when another User (Simon) who was on the same vacation finds the information and adds to the information, Katia can be notified.

Alternatively, a User may request that the system create a “trigger” on behalf of the User such that the User is notified whenever an Event is added that matches the conditions of the trigger. Using a structured data language as was described above, a trigger can be easily represented as, for example, text in each of the element fields that the User wants to have matched. For example, a trigger could take the form of:

<XirchTrigger>

<WhatElementList>

<What>Vacation</What>

</WhatElementList>
<Where>

<LocationName>Fictional Hotel</LocationName>
<Country>Bahamas</Country>

</Where>
<When>

<StartDateTime>2000/01/01</StartDateTime>
<EndDateTime>2000/01/14</EndDateTime>

</When>

</XirchTrigger>

As would be appreciated by those of ordinary skill in the art, “wildcard” values and Boolean operators can be utilized to enable greater flexibility in searching. For example, if a User could remember a last name but was not sure of a first name, the User may specify “Tom or Tim” as the parameter for the first name.

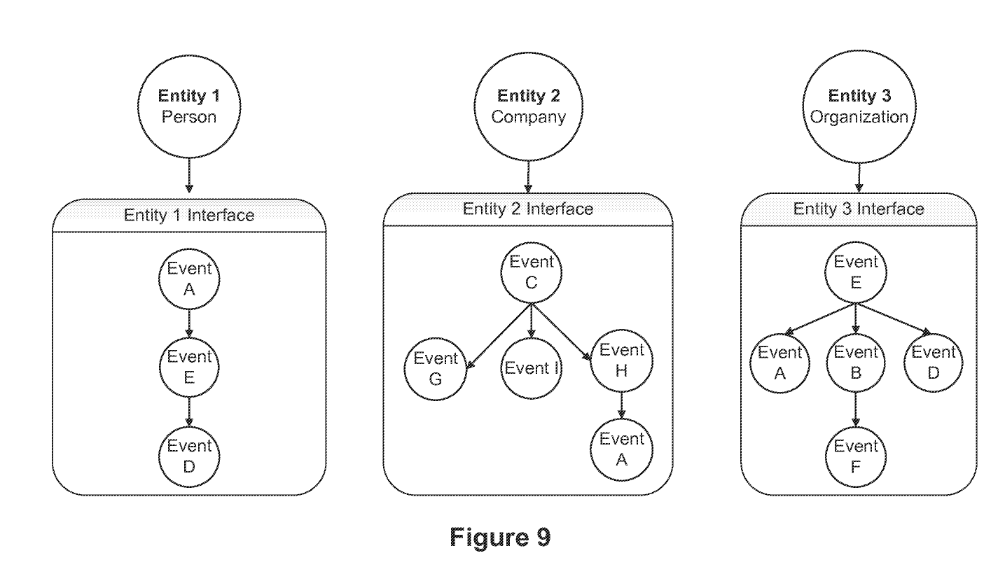

In order to facilitate enhanced interconnectivity and expandability, a multi-layer hierarchical method has been devised to provide independent hierarchical structures for each Event's connected Users. This method allows the User to arrange and structure an Event in the most logical manner for their specific needs and is not determined by another User's hierarchical structure or how the Event is linked/connected internally in the system. (See FIG. 9.)

While certain configurations of structures have been illustrated for the purposes of presenting the basic structures of the present invention, one of ordinary skill in the art will appreciate that other variations are possible which would still fall within the scope of the appended claims.

1. A computer-implemented system, comprising:
a processor;
digital computer memory for storing instructions for controlling the processor to perform the steps of:
storing plural classifications for a first event to enable the first event to be found in a search for the first event, the plural classifications including at least one each of: a first descriptor, a first location factor and a first time factor;
storing plural classifications for a second event to enable the second event to be found in a search for the second event, the plural classifications including at least one each of: a second descriptor, a second location factor and a second time factor;
receiving a search request for the first event using at least one of the plural classifications for the first event;
receiving a search request for the second event using at least one of the plural classifications for the second event;
providing information about the first and second events to a requester using a communications protocol;
receiving information common to the first and second events, wherein the received information is different from the first and second descriptors, the first and second location factors and the first and second time factors; and
linking the first and second events using the received information common to the first and second events.

2. The computer system as claimed in claim 1, wherein the first event is a fictitious event and the first event location factor and the first time factor are fictitious.

3. The computer system as claimed in claim 1, wherein the first and second events are provided to the requester in temporal order based on the temporal relationship between the first and second events.

4. The computer system as claimed in claim 3, wherein the temporal order based on the temporal relationship between the first and second events is represented as part of a timeline.

5. The computer system as claimed in claim 1, wherein the processor further performs the step of associating supplemental data with the first event.

6. The computer system as claimed in claim 5, wherein the supplemental data comprises at least one of photos, videos, audio files, stories, autobiography chapters, and hyperlinks.

7. The computer system as claimed in claim 1, wherein the processor further performs the step of associating supplemental data with the first and second events.

8. The computer system as claimed in claim 7, wherein the supplemental data comprises at least one of photos, videos, audio files, stories, autobiography chapters, and hyperlinks.

9. The computer system as claimed in claim 1, wherein the event location comprises information from a map.

10. The computer system as claimed in claim 1, wherein the processor further performs the step of storing trigger information to notify an entity when additional information about the first event is associated with the first event.

11. The computer system as claimed in claim 1, wherein the processor further performs the step of storing trigger information to notify an entity when information about the first event has changed.

12. The computer system as claimed in claim 1, wherein the information common to the first and second events is hierarchical information, and wherein linking the first and second events comprises grouping the first and second events hierarchically.

13. The computer system as claimed in claim 1, wherein access to the first and second events is limited to members of a group to which the first and second events are associated.

14. The computer system as claimed in claim 1, wherein the processor further performs the step of searching for a third event based on the received information common to the first and second events.

15. The computer system as claimed in claim 1, wherein the processor further performs the step of receiving relationship information about the first and second events and relating the first and second events based on the received relationship information.

16. The computer system as claimed in claim 1, wherein the plural classifications for the first event are stored together as part of a common data representation of the first event, and wherein the plural classifications for the second event are stored together as part of a common data representation of the second event.

17. The computer system as claimed in claim 1, wherein the processor further performs the step of storing trigger information to notify an entity when a third event has been added that is related to the first and second events based on the received information common to the first and second events.

18. The computer system as claimed in claim 1, wherein the first and second events are shared with users using a social networking system.

19. The computer system as claimed in claim 1, wherein receiving a search request for the first event using at least one of the plural classifications for the first event and receiving a search request for the second event using at least one of the plural classifications for the second event comprise receiving a single search request for the first and second events.

20. A computer-implemented method for controlling a processor to execute computer instructions stored in a digital computer memory, the method comprising:
storing plural classifications for a first event to enable the first event to be found in a search for the first event, the plural classifications including at least one each of: a first descriptor, a first location factor and a first time factor;
storing plural classifications for a second event to enable the second event to be found in a search for the second event, the plural classifications including at least one each of: a second descriptor, a second location factor and a second time factor;
receiving a search request for the first event using at least one of the plural classifications for the first event;
receiving a search request for the second event using at least one of the plural classifications for the second event;
providing information about the first and second events to a requester using a communications protocol;
receiving information common to the first and second events, wherein the received information is different from the first and second descriptors, the first and second location factors and the first and second time factors; and
linking the first and second events using the received information common to the first and second events.

21. A non-transitory computer-readable medium for controlling a processor to execute computer instructions stored therein, comprising:
computer instructions stored in the computer-readable medium for storing plural classifications for a first event to enable the first event to be found in a search for the first event, the plural classifications including at least one each of: a first descriptor, a first location factor and a first time factor;
computer instructions stored in the computer-readable medium for storing plural classifications for a second event to enable the second event to be found in a search for the second event, the plural classifications including at least one each of: a second descriptor, a second location factor and a second time factor;
computer instructions stored in the computer-readable medium for receiving a search request for the first event using at least one of the plural classifications for the first event;
computer instructions stored in the computer-readable medium for receiving a search request for the second event using at least one of the plural classifications for the second event;
computer instructions stored in the computer-readable medium for providing information about the first and second events to a requester using a communications protocol;
computer instructions stored in the computer-readable medium for receiving information common to the first and second events, wherein the received information is different from the first and second descriptors, the first and second location factors and the first and second time factors; and
computer instructions stored in the computer-readable medium for linking the first and second events using the received information common to the first and second events.
